(19) United States
(12) Patent Application Publication
(10) Pub. No.: US 2024/0106387 A1
(43) Pub. Date: Mar. 28, 2024

(54) PHOTOVOLTAIC AGRICULTURAL INSTALLATION

(71) Applicant: Darren BRUINS, Calgary (CA)

(72) Inventor: Darren BRUINS, Calgary (CA)

(21) Appl. No.: 17/951,279

(22) Filed: Sep. 23, 2022

(51) Int. Cl. H02S 20/32; H02S 40/36

(52) U.S. Cl. CPC H02S 20/32; H02S 40/36

(57) ABSTRACT

A photovoltaic installation utilizing the “wasted” land created by the implementation of a center-pivot irrigation system, causing no damage to the root systems of native grasses or ground cover on “wasted” portions of that land. Further, this system can be removed with no footprint should a viable agricultural use be found for the land and re-purposed on another “wasted” area. The installation includes an array of photovoltaic panel support units having photovoltaic panels connected thereto. The support units are arranged to cover at least part of a non-irrigated portion of a field irrigated by the center-pivot irrigation system. Electrical power generated by the installation may be routed to the larger grid to offset the power required by the center-pivot irrigation system to drive rotation of the center-pivot irrigation system and pumping of water through the center-pivot irrigation system. Excess renewable energy can also be resold via the grid depending on the regulatory framework of the location of the system.

### FIELD

The invention relates to photovoltaic installations and more specifically to photovoltaic installations associated with agricultural applications.

### BACKGROUND

Renewable energy is energy that is collected from renewable resources, which are naturally replenished on a human timescale, such as sunlight, wind, rain, tides, waves, and geothermal heat. Renewable energy often provides energy in four important areas: electricity generation, air and water heating/cooling, transportation, and rural (off-grid) energy services.

Renewable energy resources exist over wide geographical areas, in contrast to other energy sources, which are concentrated in a limited number of countries. Rapid deployment of renewable energy and energy efficiency is resulting in significant energy security, climate change mitigation, and economic benefits. As greenhouse gas (GHG) emitters begin to be held liable for damages resulting from GHG emissions resulting in climate change, a high value for liability mitigation would provide powerful incentives for deployment of renewable energy technologies. In international public opinion surveys there is strong support for promoting renewable sources such as solar power and wind power. At least 30 nations already have renewable energy contributing more than 20 percent of energy supply. National renewable energy markets are projected to continue to grow strongly in the coming decade and beyond. Iceland and Norway generate all their electricity using renewable energy already, and many other countries have the set a goal to reach 100% renewable energy in the future.

Solar energy is radiant light and heat from the sun that is harnessed using a range of ever-evolving technologies such as solar heating, photovoltaics, solar thermal energy, solar architecture, molten salt power plants and artificial photosynthesis.

It is an important source of renewable energy and its technologies are broadly characterized as either passive solar or active solar depending on how they capture and distribute solar energy or convert it into solar power. Active solar techniques include the use of photovoltaic systems, concentrated solar power and solar water heating to harness the energy. Passive solar techniques include orienting a building to the sun, selecting materials with favorable thermal mass or light-dispersing properties, and designing spaces that naturally circulate air. Passive solar techniques are thus expected to increase energy security through reliance on an indigenous, inexhaustible and mostly import-independent resource, enhance sustainability, reduce pollution, and lower the costs of mitigating global warming.

U.S. Pat. No. 9,318,994, incorporated herein by reference in its entirety, describes a multistage vertical solar module holder. Because solar modules are installed between vertical members vertically installed on the bottom surface in a ladder type in multiple stages to be inclined by inclination maintenance units, a large number of solar cell modules can be installed in a single area and a large number of modules can be installed in a plurality of rows. Further, a shadow of an upper module does not hide a lower module by maintaining the vertical interval of the modules sufficiently, and the holders can be installed while rows of modules and the sunlight irradiation angle can be sufficiently maintained, so that high efficiency of solar power generation can be realized. In addition, because several rows of solar modules are installed in multiple stages by utilizing a vertical space for the solar module on the ground such as a rice paddy, a field or a forest, solar power generation can be realized together with farming, which helps the economy of farms. Further, the solar modules can be installed in a narrow place such as the side of a road, the side of a railroad, and a bank.

US Patent Publication No. 2014/0352757, incorporated herein by reference in its entirety, describes a smart multi-axis rotating case for a variety of products and functions for alternative ways in which to use solar power. One embodiment is a device such as a 2 axis dual pitch solar tracking case to track the rotation of the sun. Smaller embodiments of the device include a personnel portable mini model for use with back packs, briefcases, laptops, bikes, wagons, emergency vehicles and more. Current solar 2 axis solar trackers are generally bulky heavy slow machines that afford little flexibility and alternative capability.

US Patent Publication No. 2015/0128930, incorporated herein by reference in its entirety, describes a sun tracking mechanism for solar power generation, including a power unit, a linear actuator and at least two universal joints. The sun tracking mechanism outputs an angle of high precision by two axial directions provided from the universal joints, the power unit and the linear actuator. A solar power module disposed on the sun tracking mechanism generates electricity in the best light incident angle. In addition, the linear actuator provides an auxiliary supporting force to improve the wind-resistant capability.

Canadian Patent 2,807,356, incorporated herein by reference in its entirety, describes an automatic solar tracking adjustment/control apparatus of a solar generation system which includes a support assembly, a two-dimensionally movable pivotal rotational assembly disposed on the support assembly, a solar generation module disposed on the support assembly via the pivotal rotational assembly for converting solar energy into electrical energy and two intersecting drive assemblies disposed between the support assembly and the solar generation module. The drive assemblies drive the solar generation module to tilt in different directions and angles according to reference parameters previously stored in a control unit. A detection/correction module is disposed on the solar generation module for detecting various parameters including tilting direction and inclination angle of the solar generation module. The control unit compares the parameters with the reference parameters to modify the operation of the drive assemblies so as to adjust the tilting direction and inclination angle of the solar generation module.

International Patent Application No. WO/2015/098749, incorporated herein by reference in its entirety, describes a relocatable photovoltaic power generation system for fields, the individual parts of which can be relocated from agricultural land that constitutes a poor foundation to different agricultural land. The system can be disassembled so as not to impede agricultural work during the agricultural season. This equipment comprises a frame that holds a solar cell panel and a pair of folding frames that are foldably affixed to the frame. A base is constructed by arranging and linking a plurality of tanks such that the position of a long side acts as an axis of symmetry, and then filling the respective tanks with water. The base and the folding frames are detachably linked by a pair of base plates that have a recessed part for transmitting loads that act on the solar cell panel to the base.

Japanese Patent 2003235354A, incorporated herein by reference in its entirety, describes a photovoltaic power generation apparatus as a light screening or shielding apparatus for use on land which is inadequate for agriculture due to latitude or dryness. The power generating elements are arranged above the ground in a reticulated form to regulate the sunlight reaching the surface of the ground to capture energy while allowing access to the ground.

Japanese Patent 2014200188, incorporated herein by reference in its entirety, describes a method for installing a solar cell panel in an unused field or rice field using shelf frames for supporting the agricultural products, spaces between rows of frames and solar cell panels installed at the top face of each of the shelf frames.

There continues to be a need for improvements in efficient deployment of solar energy-generating installations.

### SUMMARY

One aspect of the invention is a process for assembling a photovoltaic installation, the process comprising: receiving a request to assemble a photovoltaic array in a field having a center-pivot irrigation system; delivering a plurality of photovoltaic module support units to a non-irrigated portion of the field; assembling the array by arranging the support units in a pattern within the non-irrigated portion; and connecting photovoltaic panels to the support units.

In some embodiments, the support units are configured for deployment in the shape of parallelograms.

In some embodiments, the support units are deployed with one or more connections to adjacent frames of the array.

In some embodiments, the support units are configured for single axis or dual-axis photovoltaic tracking.

In some embodiments, each of the support units has an area of between about 27 and 30 square meters.

In some embodiments, the support units are each configured to support four sets of photovoltaic panels.

In some embodiments, the photovoltaic panels are 60-cell photovoltaic panels or 72-cell photovoltaic panels.

In some embodiments, the non-irrigated portion is in the shape of an arched triangle, the shape of two adjacent arched triangles or the shape of four adjacent arched triangles, or any combination thereof.

In some embodiments, the field is a square and includes four center irrigation pivots, each centered in quarters of the square, thereby defining nine non-irrigated portions including four arched triangles at the corners of the square, four arched triangles substantially centered on the mid-point of each edge of the square and a central curved diamond shape in the center of the field,

In some embodiments, the process is repeated to deploy a plurality of photovoltaic arrays in the field with one array of the plurality of photovoltaic arrays deployed in each one of the arched triangles.

In some embodiments, the field is square and includes one center irrigation pivot center in the square, thereby defining four non-irrigated portions including four arched triangles at the corners of the square.

In some embodiments, the process is repeated to deploy a plurality of photovoltaic arrays in the field with one array of the plurality of photovoltaic arrays deployed in each one of the arched triangles and the central curved diamond shape.

In some embodiments, the support units are less than about one meter in height and are installable without a subsurface foundation.

In some embodiments, the support units have an armature under computer control to rotate the photovoltaic panels to maximize exposure to the sun and to minimize exposure to shadows cast by adjacent panels.

Another aspect of the invention is a photovoltaic power generating installation comprising: an array of photovoltaic panel support units having photovoltaic panels connected thereto, the support units arranged in a pattern to cover at least a part of a non-irrigated portion of a field irrigated by a center-pivot irrigation system.

In some embodiments, the support units are configured for deployment in the shape of parallelograms.

In some embodiments, the support units are deployed with one or more connections to adjacent support units of the array.

In some embodiments, the support units are configured for single axis or dual-axis photovoltaic tracking.

In some embodiments, each of the support units has an area of between about 27 and 30 square meters.

In some embodiments, the support units are each configured to support four sets of photovoltaic panels.

In some embodiments, the photovoltaic panels are 60-cell photovoltaic panels or 72-cell photovoltaic panels.

In some embodiments, the non-irrigated portion is in the shape of an arched triangle, the shape of two adjacent arched triangles or the shape of four adjacent arched triangles.

In some embodiments, the field is a square and includes four center irrigation pivots, each centered in quarters of the square, thereby defining nine non-irrigated portions including four arched triangles at the corners of the square, four arched triangles substantially centered on the mid-point of each edge of the square and a central curved diamond shape in the center of the field,

In some embodiments, the installation includes a plurality of photovoltaic arrays in the field with one array of the plurality of photovoltaic arrays deployed in each one of the arched triangles.

In some embodiments, the field is square and includes one center irrigation pivot center in the square, thereby defining four non-irrigated portions including four arched triangles at the corners of the square, wherein an array is deployed in each one of the arched triangles.

In some embodiments, the installation includes a plurality of photovoltaic arrays in the field with one array of the plurality of photovoltaic arrays deployed in each one of the arched triangles and the central curved diamond shape.

In some embodiments, the support units are less than about one meter in height and are installable without a subsurface foundation.

In some embodiments, the support units have an armature under computer control to rotate the photovoltaic panels to maximize exposure to the sun and to minimize exposure to shadows cast by adjacent panels.

Another aspect of the invention is a photovoltaic installation for powering a center-pivot irrigation system, the installation comprising: an array of photovoltaic panel support units having photovoltaic panels connected thereto, the support units arranged to cover at least part of a non-irrigated portion of a field irrigated by the center-pivot irrigation system, wherein electrical power generated by the installation is routed to the center-pivot irrigation system to drive rotation of the center-pivot irrigation system and pumping of water through the center-pivot irrigation system.

In some embodiments, the installation is further configured with an external electrical power line to transmit excess electrical energy to an external grid system, the external electrical power line having a meter connected thereto for measurement of electrical power transmitted to the external grid system.

In some embodiments, the support units are configured for deployment in the shape of parallelograms.

In some embodiments, the support units are deployed with one or more connections to adjacent support units of the array.

In some embodiments, the support units are configured for single axis or dual-axis photovoltaic tracking.

In some embodiments, each of the support units has an area of between about 27 and 30 square meters.

In some embodiments, the support units are each configured to support four sets of photovoltaic panels.

In some embodiments, the photovoltaic panels are 60-cell photovoltaic panels or 72-cell photovoltaic panels.

In some embodiments, the non-irrigated portion is in the shape of an arched triangle, the shape of two adjacent arched triangles or the shape of four adjacent arched triangles.

In some embodiments, the field is a square and includes four center irrigation pivots, each centered in quarters of the square, thereby defining nine non-irrigated portions including four arched triangles at the corners of the square, four arched triangles substantially centered on the mid-point of each edge of the square and a central curved diamond shape in the center of the field,

In some embodiments, the installation includes a plurality of photovoltaic arrays in the field with one array of the plurality of photovoltaic arrays deployed in each one of the arched triangles.

In some embodiments, the field is square and includes one center irrigation pivot center in the square, thereby defining four non-irrigated portions including four arched triangles at the corners of the square, wherein an array is deployed in each one of the arched triangles.

In some embodiments, the installation includes a plurality of photovoltaic arrays in the field with one array of the plurality of photovoltaic arrays deployed in each one of the arched triangles and the central curved diamond shape.

In some embodiments, the support units are less than about one meter in height and are installable without a subsurface foundation.

In some embodiments, the support units have an armature under computer control to rotate the photovoltaic panels to maximize exposure to the sun and to minimize exposure to shadows cast by adjacent panels.

### BRIEF DESCRIPTION OF THE DRAWINGS

Various objects, features and advantages of the invention will be apparent from the following description of particular embodiments of the invention, as illustrated in the accompanying drawings. The drawings are not necessarily to scale, emphasis instead being placed upon illustrating the principles of various embodiments of the invention. Similar reference numerals indicate similar components.

FIG. 1 is a satellite image of an area of agricultural land obtained from Google Earth which shows three different arrangements for irrigating sections and quarter sections of land using center-pivot irrigation.

FIG. 2A is a schematic representation of a section of land 1 which is one square mile in area and divided into four quarter sections 10, 20, 30 and 40, each having a corresponding center-pivot 12, 22, 32 and 42 placed therein.

FIG. 2B is the same schematic representation of section 1 of FIG. 2A with a photovoltaic array 14A-PV assembled in the top right non-irrigated portion 14A of the top right quarter 10.

FIG. 2C is the same schematic representation of section 1 of FIG. 2A with four photovoltaic arrays 14A-PV, 14A-PV, 14A-PV and 14D-PV installed in the four non-irrigated portions of the top right quarter 10.

FIG. 2D is the same schematic representation of section 1 of FIG. 2A with photovoltaic arrays installed in each one of the non-irrigated portions of the section 1.

FIG. 3 is a schematic representation of an undivided section of land 2 which is one square mile in area with a single center-pivot 52 placed therein. Photovoltaic arrays 54A-PV, 54B-PV, 54C-PV and 54D-PV are installed in each of the four non-irrigated portions of the section 2.

FIG. 4 is a schematic representation of a process for assembly of a photovoltaic array 200 formed of photovoltaic units 160, each assembled from a photovoltaic support unit frame 100 which is configured to support four photovoltaic modules 105a, 105b, 105c and 105d.

FIG. 5 is a schematic representation of a photovoltaic array 300 assembled in a non-irrigated area of a field next to a boundary with an irrigated area.

### DETAILED DESCRIPTION

### Rationale and Advantages

Photovoltaic energy generating installations require flat, vegetation free land with proper drainage, security (fencing), access (government serviced roads) and physical infrastructure (power lines, transformers, etc.). Land with these characteristics generally has more value as residential, commercial or recreational property than it would have if it were to be used for generation of renewable energy. In almost all cases, suitable land for renewable energy production is being used for other purposes or is expensive to develop, especially on small scales. In the past, these shortcomings have been addressed by spending valuable time and money to physically transform land, control vegetation, build roads and infrastructure, and to adhere to complex zoning regulations and environmental regulations.

It is challenging to identify land which is suitable for renewable energy generating installations that is not being used or planned to be used for other purposes. Furthermore, a suitable location will require construction and ongoing management of the site.

Using Alberta, Canada as an example, regulations dictate that all land that is to be serviced by an irrigation district must first be accessible to ensure that the irrigation resource (water) will be maximized. This requires several conditions to be met, some of which include (i) prohibition of earthworks to allow the root systems of native grasses to continue to provide soil erosion protection; (ii) the parcel of land must be no less than 160 acres (in most cases); (iii) the parcel of land must have a relatively flat geologic profile with a low grade of elevation changes (no geological barriers such as eskers, drumlins and chasms); (iv) there must be satisfactory drainage to prevent accumulation of standing water and streams of run-off; (v) there must be no unmanaged vegetation or forestation; (vi) irrigation equipment must be protected with fencing and signage; (vii) the land must be zoned for agriculture; and (viii) the land must have proper access to canals, roads and other physical infrastructure.

The vast majority of land approved for irrigation in Alberta is in the form of 160-acre (64.7 hectare) lots (representing quarter divisions of traditional square mile sections) that are flat, dry, secure and accessible.

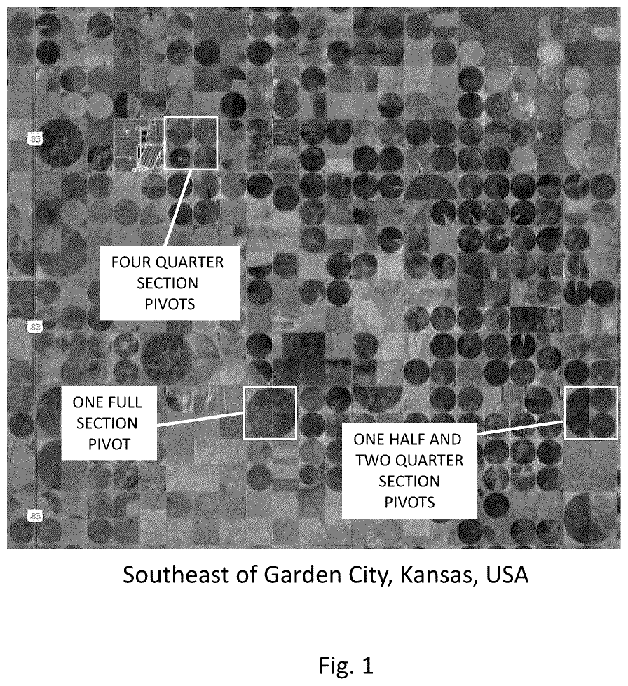

In most cases, the most economical and efficient way to irrigate crops on these parcels of land is to utilize a center-pivot irrigation system. In most cases, circular-shaped irrigation areas cover as much of the field as possible but always leave non-irrigated corners that cannot be reached by the center-pivot irrigation system. In the case of a center-pivot irrigation system designed to cover a 160-acre quarter section, the system generates a circular irrigated area that covers approximately 126 of the 160 acres and leaves 4 corners of approximately 8 acres each. In other cases, when an entire square mile section is approved for irrigation, it is either provided with a single large center-irrigation pivot to generate a single large irrigated circle with four non-irrigated corners, or more commonly, is divided into quarter sections, with each quarter section provided with a center-pivot irrigation systems which generate four circles, each centered in its corresponding quarter section (examples of these arrangements are seen in the satellite image shown in FIG. 1 obtained from Google Earth (http://maps.google.com) representing a view of agricultural land southeast of Garden City, Kansas, USA). This image highlights one example of four center-pivots in a single section (upper left), a single full section pivot (lower left) and a section having a half-section pivot on the left and two quarter section pivots on the right (lower right). In each of these cases, about 21% of the total area of a square mile section includes corners which are non-irrigated. These non-irrigated areas generally are not used for any useful purpose and are considered to be “wasted” land. In most cases, this wasted land is covered with native grass, to allow for moisture and soil conservation.

The inventors of the present technology have discovered that the unused corners of square or rectangular fields irrigated with center-pivot irrigation systems are ideally suited for installation of photovoltaic equipment for generation of renewable energy. Embodiments of the present invention are now described to address the problem of providing suitable land for photovoltaic energy generation. The unused corners or non-irrigated areas may be substantially covered with photovoltaic arrays or partially covered, depending upon the objectives of the installation. One possible objective is to generate as much energy as possible using the available land area and to feed electricity into a municipal or regional electrical grid (as would be done, for example by an electrical utility company). This objective would benefit from an attempt to optimize the array pattern to pack in as many photovoltaic units as possible. Another possible objective is to simply generate sufficient energy to power the center pivot irrigation system, in which case, it may not be necessary to optimize placement of photovoltaic arrays for maximal energy generation (such an arrangement could still be equipped to transmit excess energy to an external electrical grid. In such cases, an array covering only part of one unused corner of the field may be sufficient, or alternatively, the installation could include any combination of smaller arrays placed in more than one corner of the field.

Various aspects of the invention will now be described with reference to the figures. For the purposes of illustration, components depicted in the figures are not necessarily drawn to scale. Instead, emphasis is placed on highlighting the various contributions of the components to the functionality of various aspects of the invention. A number of possible alternative features are introduced during the course of this description. It is to be understood that, according to the knowledge and judgment of persons skilled in the art, such alternative features may be substituted in various combinations to arrive at different embodiments of the present invention.

Deployment of Arrays of Photovoltaic Units in Non-Irrigated Portions of a Field Irrigated with Center-Pivot Irrigation Systems

Referring now to FIG. 1, there is shown a schematic representation of a square mile section of land 1 which is subdivided into four sections 10, 20, 30 and 40 (with the divisions indicated with dashed lines). Each section has a corresponding center-pivot irrigation system which forms an irrigated circle. As such, pivot 12 is centered in section 10, pivot 22 is centered in section 20, pivot 32 is centered in section 30, and pivot 42 is centered in section 40.

Each quarter section has four non-irrigated areas to provide the entire section 1 with nine non-irrigated portions, some of which are formed by adjoining non-irrigated portions of adjacent sections. As such, quarter 10 has non-irrigated portions 14A, 14B, 14C and 14D, quarter 20 has non-irrigated portions 24A, 24B, 24C and 24D, quarter 30 has non-irrigated portions 34A, 34B, 34C and 34D and quarter 40 has non-irrigated portions 44A, 44B, 44C and 44D. Each of the four non-irrigated portions of each quarter is in the shape of an arched triangle. The four corners of the section 1 have arched triangles 14A, 24B, 34C and 44D, each of which has an arch on one side which forms the boundary with the circle formed by the center-pivot irrigation system. In addition, there are four larger arched triangles each having two curved sides which are formed by adjoining arched triangles (for example the top arched triangle of this type is formed of non-irrigated portions 14B and 24A). These four arched triangles are substantially centered on the mid-point of each edge of the square section 1. There is also a central curved diamond-shaped area formed by the four central non-irrigated portions 14D, 24C, 34B and 44D.

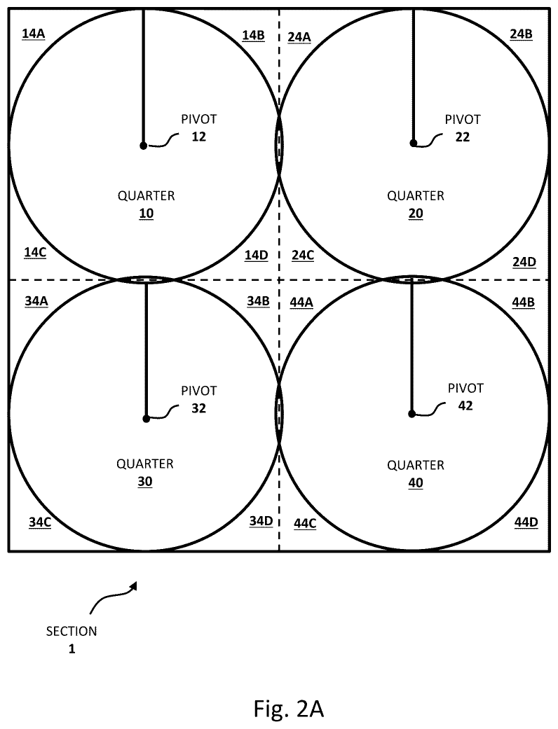

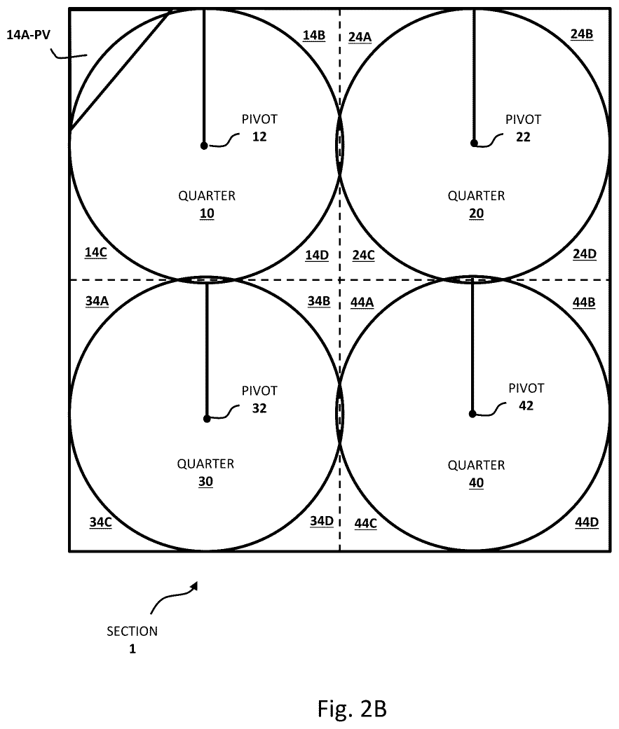

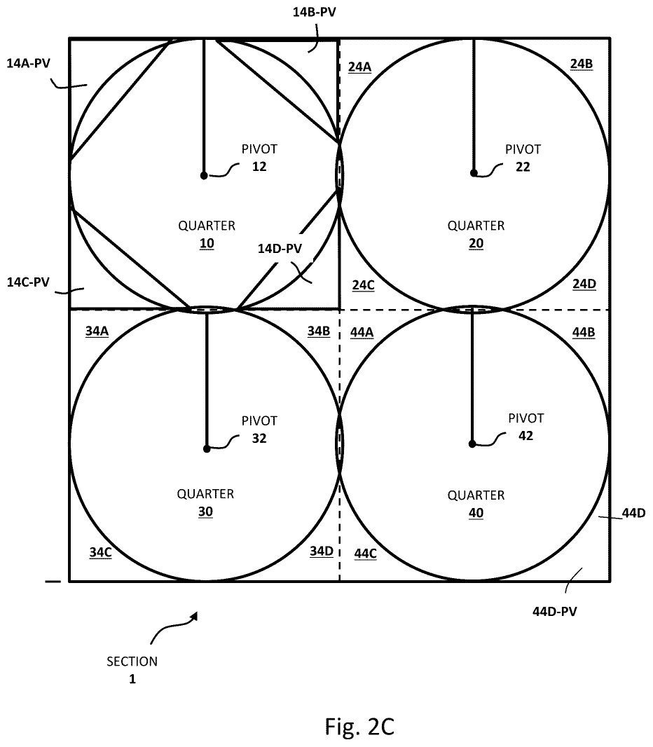

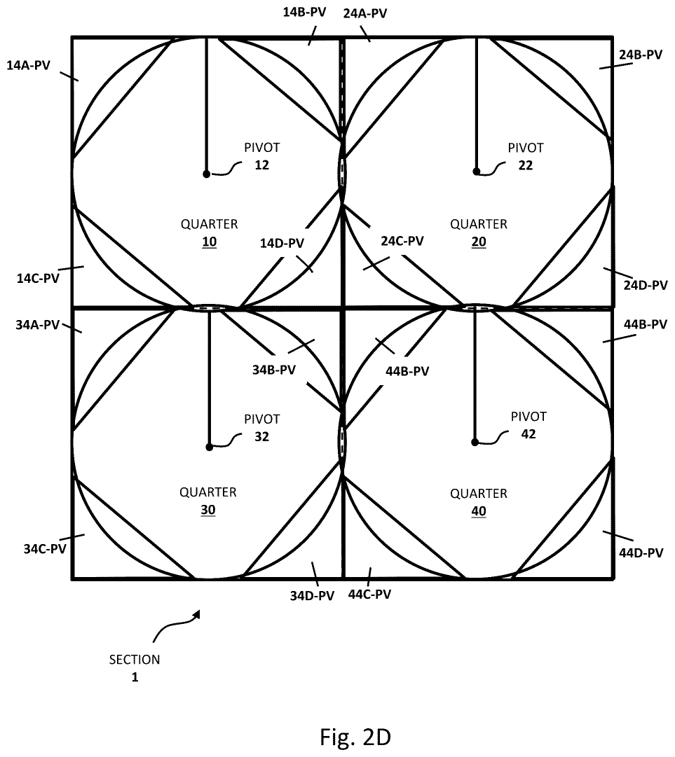

Turning now to FIG. 2B, it is seen that a single array of photovoltaic units (indicated by the filled checkered pattern) has been deployed with substantial coverage in non-irrigated portion 14A to generate photovoltaic array 14A-PV. This represents one embodiment of a photovoltaic installation in accordance with the invention. Other embodiments will include additional photovoltaic arrays in one or more additional non-irrigated portions. Another embodiment is shown in FIG. 2C wherein each one of the four non-irrigated portions of quarter 10 has been substantially covered by a corresponding photovoltaic array to provide four photovoltaic arrays 14A-PV, 14B-PV, 14C-PV and 14D-PV. As used herein, the term “substantially covered” means that installation of the array was conducted with the objective of maximizing photovoltaic energy output by installing as many photovoltaic units as possible, within reasonable approximation, on a non-irrigated portion. Procedures for substantially covering a non-irrigated portion with a photovoltaic array may be simulated and optimized by computer modelling for example. Such computer models may be developed by a person having ordinary skill in the art, without undue experimentation. The remaining non-irrigated portions of the other three quarters 20, 30 and 40 with the exception of 44D remain in their original state, without placement of photovoltaic arrays. Non-irrigated portion 44D of quarter 40 is only partially covered with a corresponding array 44D-PV to illustrate an additional embodiment wherein at least one photovoltaic array which covers at least part of a non-irrigated portion. Other embodiments will have at least one photovoltaic array covering less than a majority portion of one or more non-irrigated portions.

Alternative embodiments will include one or more additional arrays in any of the remaining non-irrigated portions 24A, 24B, 24C, 24D, 34A, 34B, 34C, 34D, 44A, 44B, 44C and 44D. In such embodiments, the arrays may cover substantially all, a majority portion or less than a majority portion in any combination.

Yet another embodiment is shown in FIG. 2D wherein all of the non-irrigated portions are substantially covered with photovoltaic arrays. As such, the non-irrigated portions of quarter 10 are substantially covered with photovoltaic arrays 14A-PV, 14B-PV, 14C-PV and 14D-PV, the non-irrigated portions of quarter 20 are substantially covered with photovoltaic arrays 24A-PV, 24B-PV, 24C-PV and 24D-PV, the non-irrigated portions of quarter 30 are substantially covered with photovoltaic arrays 34A-PV, 34B-PV, 34C-PV and 34D-PV, and the non-irrigated portions of quarter 40 are substantially covered with photovoltaic arrays 44A-PV, 44B-PV, 44C-PV and 44D-PV.

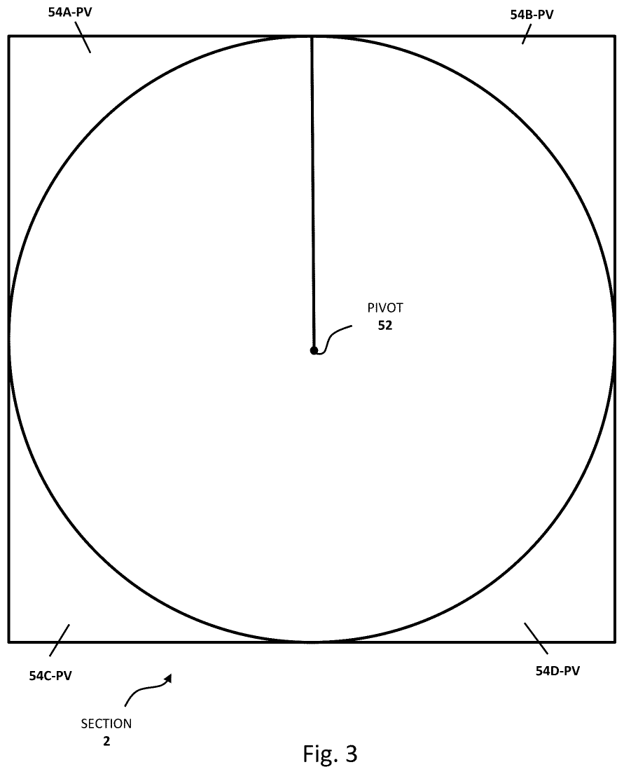

Another embodiment is shown in FIG. 3 which illustrates a schematic representation of a square mile section of land 2 which is not subdivided into quarters and which includes a single center pivot 52 which is configured to provide an irrigated circle with a radius reaching each one of the four section boundaries. In this particular embodiment, each one of the non-irrigated areas is substantially covered by a corresponding array to provide four arrays 54A-PV, 54B-PV, 54C-PV and 54D-PV. Alternative embodiments based generally on this embodiment will have one or more of the four non-irrigated areas only partially covered by a corresponding array.

### Assembly of Photovoltaic Arrays of Photovoltaic Support Units

It is advantageous to select a modular system of photovoltaic support units to use as the “building blocks” of photovoltaic arrays. In one particular embodiment, the modular system employed in various processes and installations described herein is the Savanna™ system marketed by Morgan Solar Inc. (Toronto, ON, Canada; http://morgansolarcom/savannapvtracked, incorporated herein by reference in its entirety). The Savanna™ system is a dual-axis photovoltaic tracker system based on a human-height drop-in-place support frame which has the capability to rotate modules of photovoltaic panels to track the movement of the sun across the sky and to avoid shadows cast by adjacent modules. Concrete supports for each unit are not required. This is advantageous because it is anticipated that center-pivot irrigation systems may be replaced with other irrigation systems in an ad-hoc manner in the future and the ability to conveniently remove photovoltaic arrays from an installation site is desirable.

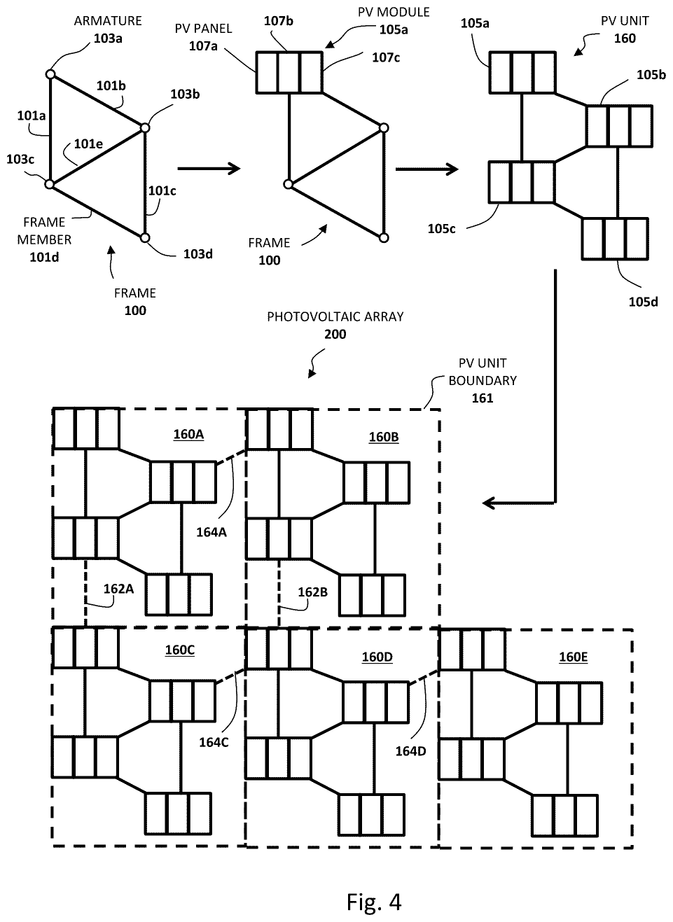

Turning now to FIG. 4, there is shown a schematic representation of a process for assembling a photovoltaic array suitable for deployment in a non-irrigated portion of a field irrigated with a center-pivot irrigation system. In the first step of the process, a frame 100 of a photovoltaic support unit is assembled. The frame includes five support members 101a, 101b, 101c, 101d and 101e which are arranged to form a parallelogram with one of the members 101e acting as a support brace to retain the parallelogram shape. Four armatures 103a, 103b, 103c and 103d are connected to the corners of the parallelogram to provide rotatable mounting of photovoltaic modules. The armatures 103a, 103b, 103c and 103d are wired to a central controller (not shown) which is programmed to rotate the armatures at specified angles on dual axes so that the photovoltaic panels will maximize exposure to the sun (as it moves across the sky) and minimize exposure to shadows cast by adjacent photovoltaic panels and/or adjacent support units. This dual axis tracking feature is included in the support units of the Savanna™ system. Other photovoltaic tracker systems may be used in alternative embodiments.

In the next step of the illustrated process of FIG. 4, a photovoltaic module 105a formed of three photovoltaic panels 107a, 107b and 107c is connected to armature 103a. This process is repeated for the remaining armatures 103b, 103c and 103d until a photovoltaic unit 160 is completed with connection of three additional photovoltaic modules to provide a total of four photovoltaic modules 105a, 105b, 105c and 105d. In some embodiments, each of the photovoltaic modules has 60 photovoltaic cells or 72 photovoltaic cells.

The arrangement shown at the top right of FIG. 4 represents a single photovoltaic unit 160. This unit 160 is used in a building-block fashion to generate a photovoltaic array which ideally will be spread over at least part of the non-irrigated portion of the field. In considering such coverage, it is helpful to include an extended photovoltaic unit boundary 161 for each photovoltaic unit 160 to provide sufficient spacing to allow extended movement of individual photovoltaic modules as well as allowing access of service workers to each photovoltaic unit 160. In one embodiment, when the Savanna™ system is used, each photovoltaic unit block bounded by the photovoltaic unit boundary 161 has dimensions of about 8.3 m×9.4 m. The bottom portion of FIG. 4 illustrates assembly of a photovoltaic array 200 from four photovoltaic units 160A, 160B, 160C, 160D and 160E by placement of units adjacent to each other on edges of the photovoltaic unit boundary 161. It is further seen that at least one interconnection is made from one photovoltaic unit to an adjacent photovoltaic unit. Thus, photovoltaic unit 160A is connected to photovoltaic unit 160B by interconnection member 164A and to photovoltaic unit 160C by interconnection member 162A; photovoltaic unit 160B is connected to photovoltaic unit 160D by interconnection member 162B; photovoltaic unit 160C is connected to photovoltaic unit 160D by interconnection member 164C; and photovoltaic unit 160D is connected to photovoltaic unit 160E by interconnection member 164D.

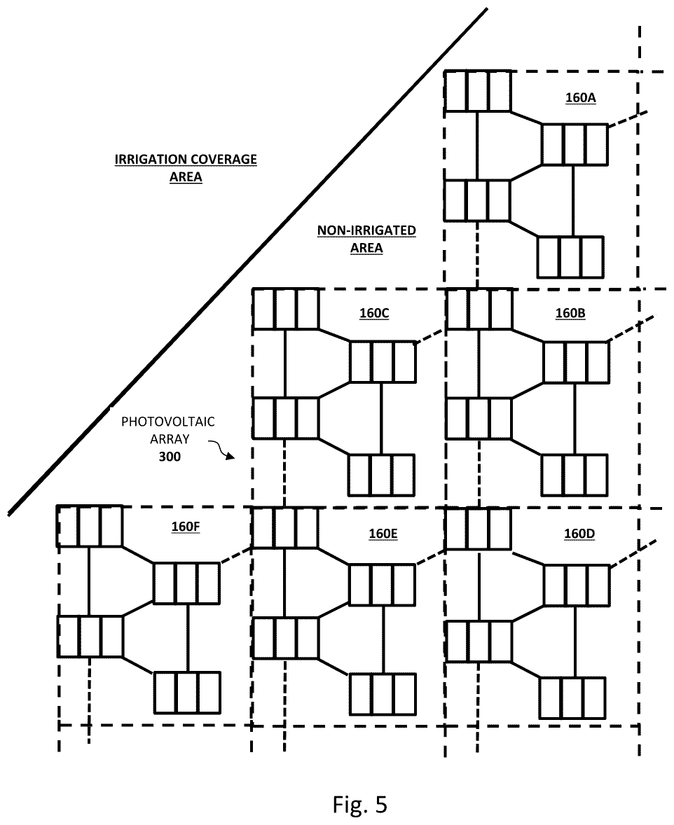

Turning now to FIG. 5, there is shown an example of part of a photovoltaic array assembled by placing photovoltaic unit 160A in a non-irrigated area of a field with a center-pivot irrigation system with one corner of the unit 160A close to the boundary between the irrigation coverage are and the non-irrigated area. Next, photovoltaic unit 160B is assembled below and adjacent to unit 160A and an interconnection is made (indicated by the vertical dashed line). Because there is sufficient room to the left of unit 160B, photovoltaic unit 160C is placed at that location. As this growing array moves farther away from the boundary with the irrigation coverage area (the solid diagonal line), there is more space available for the next row of units. Unit 160D is placed below unit 160B, unit 160E is placed below unit 160C and unit 160F is placed to the left of unit 160E. Appropriate interconnections are then made (indicated by vertical dashed lines between individual units).

### Photovoltaic Installation Assembly Service

Another aspect of the invention is a service based on a process for assembling photovoltaic installations. In the process, a request to initiate assembly of a photovoltaic installation is received from a land-owner, or irrigation equipment operator or an intermediary thereof. The request indicates that the installation is to be conducted at a site having at least one center-pivot irrigation system. Upon receipt of the request, photovoltaic support unit frames and photovoltaic modules are shipped to the site. In some embodiments, the dimensions of the non-irrigated portions of the site are measured and an optimal pattern of photovoltaic units to deploy on the non-irrigated portions is determined by conducting a geometrical analysis. In some embodiments, the geometrical analysis is facilitated by a computer model having algorithm which calculates an optimal pattern for a photovoltaic array formed from one type of photovoltaic module support unit or formed from more than one different type of photovoltaic module support unit. In some embodiments, an optimal coverage area is constrained by costs, taking into consideration the energy needs of the site and the costs of the equipment and labor required to assemble the array using one or more types of photovoltaic module support units. In some embodiments, natural or man-made obstacles located in the non-irrigated portion(s) are taken into account in the geometrical analysis.

The advantage to conducting a geometrical analysis is that an exact number of photovoltaic units and the associated cost can be readily determined.

The disadvantage of conducting a geometrical analysis is that assembly of an array according to these principles may be more complicated and prone to propagation of placement errors which will disrupt the process of assembly of the array.

In some embodiments, significant assumptions and approximations are used to develop a pattern for the array in efforts to generally improve the extent of photovoltaic coverage of a given non-irrigated portion while reducing the likelihood that relatively minor deviations from desired placement of support units will cause the pattern of assembled support units of the array to be significantly disrupted. As noted above, this array may be pre-designed in a set pattern in an attempt to maximize or optimize coverage are or may be simply assembled without a set pattern but forming a generally pattern which is dictated by an arbitrarily chosen starting point and placement of adjacent units wherever sufficient space is available in the non-irrigated portion of the field.

In other embodiments, an excess number of support units and panels are shipped to the field and simply assembled manually with rough guidelines for assembly of the array from defined starting points to generate a pattern for the array.

### Equivalents and Scope

The terms “one,” “a,” or “an” as used herein are intended to include “at least one” or “one or more,” unless otherwise indicated.

Any patent, publication, internet site, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Unless otherwise defined, all technical and scientific terms used herein have the same meaning as commonly understood by one of ordinary skill in the art to which this invention belongs.

While this invention has been particularly shown and described with references to embodiments thereof, it will be understood by those skilled in the art that various changes in form and details may be made therein without departing from the scope of the invention encompassed by the appended claims.

1. A photovoltaic power generating installation comprising: an array of photovoltaic panel support units having photovoltaic panels connected thereto, the support units arranged in a pattern to cover at least a part of a non-irrigated portion of a field irrigated by a center-pivot irrigation system.

2. The installation of claim 1, wherein the support units are configured for deployment in the shape of parallelograms.

3. The installation of claim 1, wherein the support units are deployed with one or more connections to adjacent support units of the array.

4. The installation of claim 1, wherein the support units are configured for single axis or dual-axis photovoltaic tracking.

5. The installation of claim 1, wherein each of the support units has an area of between about 27 and 30 square meters.

6. The installation of claim 1, wherein the support units are each configured to support four sets of photovoltaic panels.

7. The installation of claim 6, wherein the photovoltaic panels are 60-cell photovoltaic panels or 72-cell photovoltaic panels.

8. The installation of claim 1, wherein the non-irrigated portion is in the shape of an arched triangle, the shape of two adjacent arched triangles or the shape of four adjacent arched triangles.

9. The installation of claim 1, wherein the field is a square and includes four center irrigation pivots, each centered in quarters of the square, thereby defining nine non-irrigated portions including four arched triangles at the corners of the square, four arched triangles substantially centered on the mid-point of each edge of the square and a central curved diamond shape in the center of the field.

10. The installation of claim 9, comprising a plurality of photovoltaic arrays in the field with one array of the plurality of photovoltaic arrays deployed in each one of the arched triangles.

11. The installation of claim 1, wherein the field is square and includes one center irrigation pivot center in the square, thereby defining four non-irrigated portions including four arched triangles at the corners of the square, wherein an array is deployed in each one of the arched triangles.

12. The installation of claim 11, comprising a plurality of photovoltaic arrays in the field with one array of the plurality of photovoltaic arrays deployed in each one of the arched triangles and the central curved diamond shape.

13. The installation of claim 1, wherein the support units are less than about one meter in height and are installable without a subsurface foundation.

14. The installation of claim 1, wherein the support units have an armature under computer control to rotate the photovoltaic panels to maximize exposure to the sun and to minimize exposure to shadows cast by adjacent panels.

15. A photovoltaic installation for powering a center-pivot irrigation system, the installation comprising the power generating installation of claim 1, the support units of the power generating installation are arranged in the pattern to cover at least part of the non-irrigated portion of the field irrigated by the center-pivot irrigation system, and wherein electrical power generated by the power generating installation is routed to the center-pivot irrigation system to drive rotation of the center-pivot irrigation system and pumping of water through the center-pivot irrigation system.

16. The installation of claim 15, further configured with an external electrical power line to transmit excess electrical energy to an external grid system, the external electrical power line having a meter connected thereto for measurement of electrical power transmitted to the external grid system.

17. The installation of claim 15, wherein the support units are configured for deployment in the shape of parallelograms.

18. The installation of claim 15, wherein the support units are deployed with one or more connections to adjacent support units of the array.

19. The installation of claim 15, wherein the support units are configured for single axis or dual-axis photovoltaic tracking.

20. The installation of claim 15, wherein each of the support units has an area of between about 27 and 30 square meters.

21. The installation of claim 15, wherein the support units are each configured to support four sets of photovoltaic panels.

22. The installation of claim 21, wherein the photovoltaic panels are 60-cell photovoltaic panels or 72-cell photovoltaic panels.

23. The installation of claim 15, wherein the non-irrigated portion is in the shape of an arched triangle, the shape of two adjacent arched triangles or the shape of four adjacent arched triangles.

24. The installation of claim 15, wherein the field is a square and includes four center irrigation pivots, each centered in quarters of the square, thereby defining nine non-irrigated portions including four arched triangles at the corners of the square, four arched triangles substantially centered on the mid-point of each edge of the square and a central curved diamond shape in the center of the field.

25. The installation of claim 24, comprising a plurality of photovoltaic arrays in the field with one array of the plurality of photovoltaic arrays deployed in each one of the arched triangles.

26. The installation of claim 15, wherein the field is square and includes one center irrigation pivot center in the square, thereby defining four non-irrigated portions including four arched triangles at the corners of the square, wherein an array is deployed in each one of the arched triangles.

27. The installation of claim 26, comprising a plurality of photovoltaic arrays in the field with one array of the plurality of photovoltaic arrays deployed in each one of the arched triangles and the central curved diamond shape.

28. The installation of claim 15, wherein the support units are less than about one meter in height and are installable without a subsurface foundation.

29. The installation of claim 15, wherein the support units have an armature under computer control to rotate the photovoltaic panels to maximize exposure to the sun and to minimize exposure to shadows cast by adjacent panels.
